(19) United States
(12) Patent Application Publication
(10) Pub. No.: US 2017/0289843 A1
(43) Pub. Date: Oct. 5, 2017

(54) METHOD AND APPARATUS FOR TRANSMITTING DATA UNIT

(71) Applicant: INDUSTRY-ACADEMIC COOPERATION FOUNDATION, YONSEI UNIVERSITY, Seoul (KR)

(72) Inventors: Jae Seok KIM, Seoul (KR); Eun Bi KU, Seoul (KR); Chul Ho CHUNG, Seoul (KR); Byung Cheol KANG, Seoul (KR)

(73) Assignee: INDUSTRY-ACADEMIC COOPERATION FOUNDATION, YONSEI U NIVERSITY, Seoul (KR)

(21) Appl. No.: 15/437,943

(22) Filed: Feb. 21, 2017

(30) Foreign Application Priority Data
Mar. 30, 2016 (KR) 10-2016-0038326

(51) Int. Cl. H04W 28/06; H04L 12/805

(52) U.S. Cl. CPC H04W 28/06; H04W 28/065; H04L 47/365

(57) ABSTRACT

Disclosed are a device for transmitting a data unit and a method of operating the same. More particularly, the device of the present disclosure includes a size determination unit for determining an optimal split size for a MAC Service Data Unit (MSDU) received from an upper layer by applying a transmission time algorithm; a unit division unit for splitting the MSDU into the determined size; and a MAC layer management unit for generating plural MAC Protocol Data Units (MPDUs) based on the split plural MSDUs and the delimiter for each of the split plural MSDUs, generating an aggregate protocol data unit by applying an aggregate transmission scheme to the generated MPDUs, and delivering the generated aggregate protocol data unit to a physical layer, thus guaranteeing reliability important for video streaming and, at the same time, increasing the throughput.

### CROSS-REFERENCE TO RELATED APPLICATION

This application claims the priority benefit of Korean Patent Application No. 10-2016-0038326, filed on Mar. 30, 2016 in the Korean Intellectual Property Office, the disclosure of which is incorporated herein by reference.

### BACKGROUND OF THE DISCLOSURE

### Field of the Disclosure

The present disclosure relates to a device for transmitting a data unit and a method of operating the same.

### Description of the Related Art

Wireless LAN systems based on IEEE 802.11 standards are increasingly required to achieve a high transmission rate due to increased use of image data and cloud systems. Here, IEEE 802.11 refers to a set of wireless local area network (WLAN) interface standards developed by the IEEE 802.11 committee for short-range communication (e.g., tens of meters to hundreds of meters).

Thereamong, in the Media Access Control (MAC) layer, various advanced technologies based on wireless LAN standard for improving throughput upon frame transmission have been proposed. Here, the 802.11 MAC standard defines a split transmission scheme (fragmentation), as a method of increasing the transmission success probability in a channel situation in which it is difficult to receive a long frame, and an aggregate transmission scheme (aggregation), as methods of increasing throughput by increasing the amount of data included in a frame.

In conventional unmanned aircraft communication, attention has focused on using the conventional wireless LAN system based on the IEEE 802.11 standard to increase the transmission success probability of frames and separately using a split transmission scheme and an aggregate transmission scheme together to increase throughput of data. Therefore, there is a problem that reliability is not guaranteed.

### RELATED DOCUMENTS

### Patent Documents

Korean Patent No. 10-0842586 entitled “METHOD FOR TRANSMITTING OF AGGREGATED MAC MPDUs INWIRELESS TELECOMMUNICATION SYSTEM AND THEREFOR SYSTEM”

U.S. Pat. No. 7,630,403 entitled “MAC AGGREGATION FRAME WITH MSDU AND FRAGMENT OF MSDU”

U.S. Pat. No. 8,363,597 entitled “MAC ARCHITECTURES FOR WIRELESS COMMUNICATIONS USING MULTIPLE PHYSICAL LAYERS”

### SUMMARY OF THE DISCLOSURE

Therefore, the present invention has been made in view of the above problems, and it is one object of the present invention to provide a device for transmitting a data unit capable of guaranteeing reliability, which is important for video streaming, and, at the same time, increasing the throughput in unmanned aircraft communication by using a split transmission scheme and an aggregate transmission scheme, the characteristics of which are incompatible with each other and which are optimized for uplink image data transmission, together, and a method of operating the same.

It is another object of the present invention to provide a device for transmitting a data unit capable of achieving high throughput performance even in environments with error due to a split optimal MSDU size and an aggregated optimal protocol data unit size by using a split transmission scheme and an aggregate transmission scheme, the characteristics of which are incompatible with each other, together, and a method of operating the same.

It is yet another object of the present invention to provide a device for transmitting a data unit capable of detecting an optimal MSDU size for each channel environment by using a split transmission scheme and an aggregate transmission scheme together, and a method of operating the same.

In accordance with an aspect of the present invention, the above and other objects can be accomplished by the provision of a device for transmitting data unit, including a size determination unit for determining an optimal split size for a MAC Service Data Unit (MSDU) received from an upper layer by applying a transmission time algorithm; a unit division unit for splitting the MSDU into the determined size; and a MAC layer management unit for generating plural MAC Protocol Data Units (MPDUs) based on the split plural MSDUs and the delimiter for each of the split plural MSDUs, generating an aggregate protocol data unit by applying an aggregate transmission scheme to the generated MPDUs, and delivering the generated aggregate protocol data unit to a physical layer.

In accordance with another aspect of the present invention, there is provided a method of transmitting a data unit, the method including a step of determining an optimal split size for an MSDU received from an upper layer by applying a transmission time algorithm; a step of splitting the MSDU into the determined size; a step of generating plural MPDUs based on the split plural MSDUs and the delimiter for each of the split plural MSDUs and generating an aggregate protocol data unit by applying an aggregate transmission scheme to the generated plural MPDUs; and a step of delivering the generated aggregate protocol data unit to a physical layer.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a block diagram illustrating the configuration of a device for transmitting a data unit according to an embodiment of the present disclosure;

FIGS. 2A and 2B illustrate embodiments of a split transmission scheme of IEEE 802.11 MAC;

FIG. 3 illustrates an embodiment of an aggregate transmission scheme of IEEE 802.11 MAC;

FIG. 4 illustrates an embodiment of a structure produced by means of a device for transmitting a data unit according to an embodiment of the present disclosure;

FIG. 5 illustrates simulation result data of a MAC algorithm environment realized by means of a device for transmitting a data unit according to an embodiment of the present disclosure; and

FIG. 6 is a flowchart illustrating a method of transmitting a data unit according to an embodiment of the present disclosure.

### DETAILED DESCRIPTION OF THE DISCLOSURE

Hereinafter, the embodiments of the present invention are described with reference to the accompanying drawings and the description thereof but are not limited thereto.

The terminology used in the present disclosure serves the purpose of describing particular embodiments only and is not intended to limit the disclosure. As used in the disclosure and the appended claims, the singular forms “a”, “an” and “the” are intended to include the plural forms as well, unless context clearly indicates otherwise. It will be further understood that the terms “includes” and/or “including,” when used in this specification, specify the presence of stated features, steps, operations, elements, and/or components, but do not preclude the presence or addition of one or more other features, steps, operations, elements, components, and/or groups thereof.

It should not be understood that arbitrary aspects or designs disclosed in “embodiments”, “examples”, “aspects”, etc. used in the specification are more satisfactory or advantageous than other aspects or designs.

In addition, the expression “or” means “inclusive or” rather than “exclusive or”. That is, unless otherwise mentioned or clearly inferred from context, the expression “x uses a or b” means any one of natural inclusive permutations.

Further, as used in the description of the invention and the appended claims, the singular forms “a”, “an” and “the” are intended to include the plural forms as well, unless context clearly indicates otherwise.

In addition, terms such as “first” and “second” are used herein merely to describe a variety of constituent elements, but the constituent elements are not limited by the terms. The terms are used only for the purpose of distinguishing one constituent element from another constituent element.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Meanwhile, in the following description of the present invention, a detailed description of known functions and configurations incorporated herein will be omitted when it may make the subject matter of the present invention unclear. The terms used in the specification are defined in consideration of functions used in the present invention, and can be changed according to the intent or conventionally used methods of clients, operators, and users. Accordingly, definitions of the terms should be understood on the basis of the entire description of the present specification.

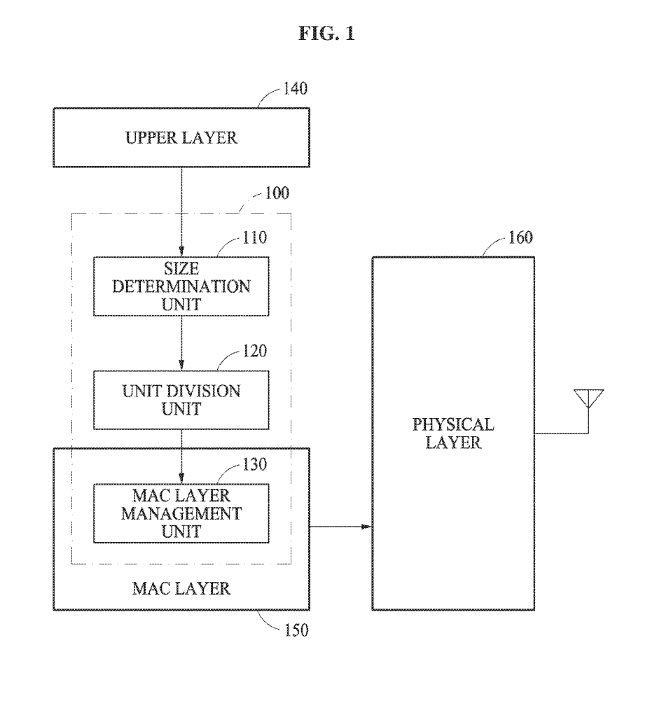

FIG. 1 is a block diagram illustrating the configuration of a device for transmitting a data unit according to an embodiment of the present disclosure.

Referring to FIG. 1, a device for transmitting a data unit 100 according to an embodiment of the present disclosure determines an optimal split size for an MSDU received from an upper layer 140, splits the MSDU into the determined size, generates plural MPDUs based on the split plural MSDUs and the delimiter for each of the plural MSDUs, generates an aggregate protocol data unit from the generated plural MPDUs, and delivers the generated aggregate protocol data unit to a physical layer 160.

To accomplish this, the device for transmitting a data unit 100 according to an embodiment of the present disclosure includes the size determination unit 110, a unit division unit 120, and a MAC layer management unit 130.

The size determination unit 110 determines an optimal split size of the received MSDU by applying a transmission time algorithm to the upper layer 140.

More particularly, the size determination unit 110 may receive data from the upper layer 140, e.g., a Logical Link Control (LLC) layer and may determine a split size of the MSDU such that the MSDU is split into smaller frame fragments than conventional frame fragments. Since reception reliability is limited depending upon channel state in the case of a long frame, this is performed to guarantee transmission reliability.

For example, the size determination unit 110 may determine an optimal split size by calculating a maximum length of a frame that can be transmitted during a Transmission Opportunity (TXOP) limit time of a terminal using a transmission time algorithm and calculating a frame transmission time from the calculated frame maximum length.

In accordance with an embodiment, the transmission time algorithm may be a transmission time (TXTIME) calculation. Using an inverse function of TXTIME, a maximum length (LENGTH) of a frame which can be transmitted for a TXOP limit time may be calculated and a transmission time (TXTIME) required to transmit the frame to a maximum length may be calculated. Here, the TXOP limit time refers to a maximum time from a start point of a right to access to the channel to a maintenance time of the channel access right to transmit and receive a frame.

In accordance with an embodiment, the size determination unit 110 may calculate a transmission time to transmit a frame to a maximum length using the transmission time algorithm frame of [Equation 1] below:

TXTIME=T_{PREAMBLE}+T_{SIGNAL}+T_{SYM}×Ceiling((16+8×LENGTH+6)/N_{DBPS}) [Equation 1]

(Here, T_{PREAMBLE} represents a transmission time of a preamble, T_{SIGNAL} represents a transmission time of a signal, T_{SYM} represents a transmission time to transmit to one symbol, and N_{DBPS} represents a data bit number included in a data symbol.

In addition CEILING((16+8×LENGTH+6)/N_{DBPS}) represents the number of data symbols.)

In addition, [Equation 2] below for calculation of a transmission time of a packet may be derived based on [Equation 1]. More particularly, by [Equation 2], a transmission time to transmit a packet, which is transmitted from an upper layer (LLC layer) to a MAC layer 150, to a maximum length may be calculated. Here, the packet represents a MAC Service Data Unit (MSDU).

TXTIME=T_{PREAMBLE}+T_{SIGNAL}+T_{SYM}×Ceiling((16+8×(L_{frame}+N_{frame}(H_{MAChdr}+FCS+Delimiter))+6)/N_{DBPS} [Equation 2]

(Here, L_{frame} represents the length of a frame, N_{frame} represents the number of a frame, H_{MAChdr} represents a MAC header, and FCS represents a frame check sequence.)

In addition, [Equation 3] below for calculation of a transmission time of a frame may be derived based on [Equation 1]. More particularly, from [Equation 3], a transmission time to transmit a frame, which is transmitted from the MAC layer 150 to the physical layer 160, to a maximum length may be calculated. Here, the frame represents a MAC Protocol Data Unit (MPDU).

TXTIME=T_{PREAMBLE}+T_{SIGNAL}+T_{SYM}×Ceiling((16+8×(L_{packet}+N_{packet}(H_{Fraghdr}+FCS_{Frag})+N_{frame}(H_{MAChdr}+FCS+Delimiter)+6)/N_{DBPS} [Equation 3]

(Here, L_{packet} represents the length of a packet, N_{packet} represents the number of packets, H_{Fraghdr} represents a fragment header, and FCS_{Frag} represents fragment FCS.)

In addition, the size determination unit 110 may calculate the throughput for performance evaluation using a transmission time algorithm.

For example, the size determination unit 110 may calculate the throughput for performance evaluation from [Equation 4] and [Equation 5] below:

T_{overhead}=T_{MAGhdr}+T_{Fraghdr}+T_{FCS}+T_{ACK} [Equation 4]

(Here, T_{MAChdr} represents a transmission time of a MAC header, T_{Fraghdr} represents a transmission time of a Frag header, T_{FCS} represents a transmission time of FCS, and T_{ACK} represents a transmission time of ACK.)

In addition, a maximum time according to a frame length is calculated from [Equation 2] and [Equation 3] and the throughput may be derived from [Equation 5] below:

$$Thr = \frac{{T}_{payload}}{{T}_{total\_frame}} = \frac{{T}_{payload}}{{T}_{payload} + {T}_{overhead}} \qquad [ Equation 5 ]$$

(Here, Thr represents throughput, T_{payload} represents a value excluding an overhead length by a MAC frame format such as a MAC header and an FCS, and Tₜₒₜₐₗ_{_}_{frame} represents a transmission time of an entire frame. In addition, the Tₜₒₜₐₗ_{_}_{frame} may be a transmission time of an entire frame calculated by [Equation 2] and [Equation 3])

Accordingly, the size determination unit 110 may determine an optimal split size of a date unit received from the upper layer 140 based on a calculated maximum length of a frame and a transmission time and throughput to transmit the frame at the maximum length, and the throughput.

In addition, the size determination unit 110 may determine an optimal split size of a service data unit received from the upper layer 140 based on a channel environment.

For example, the size determination unit 110 may determine an optimal split size of a service date unit for each channel environment according to at least one channel environment of MCS8 78 Mbps and MCS9 780 Mbps or a channel environment in which it is difficult to investigate Channel State Information (CSI).

The unit division unit 120 splits a service data unit into a determined size. More particularly, the unit division unit 120 may determine split of a service data unit received from the upper layer 140 based on an environment depending upon error occurrence. For example, in an environment in which error does not occur, the unit division unit 120 does not split the service data unit received from the upper layer 140. On the other hand, in an environment in which error occurs, the unit division unit 120 may split the service data unit received from the upper layer 140 by applying a split transmission scheme based on a size determined by the size determination unit 110.

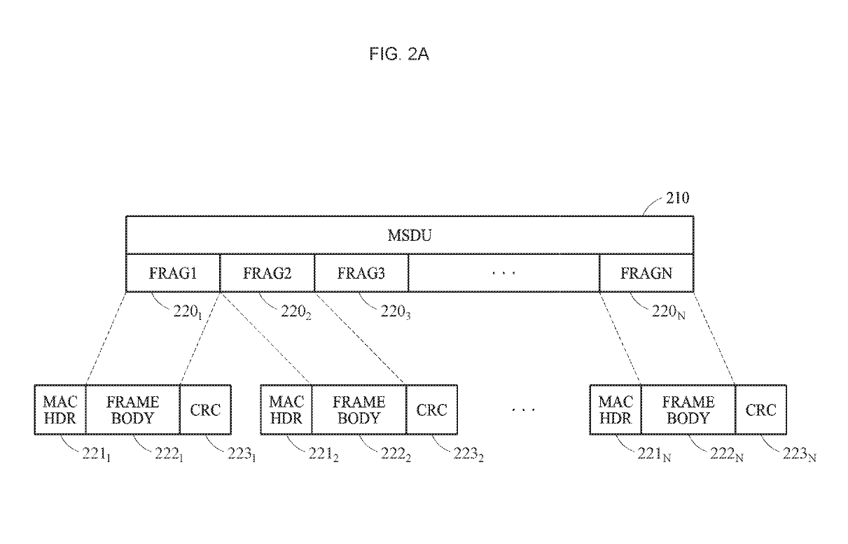

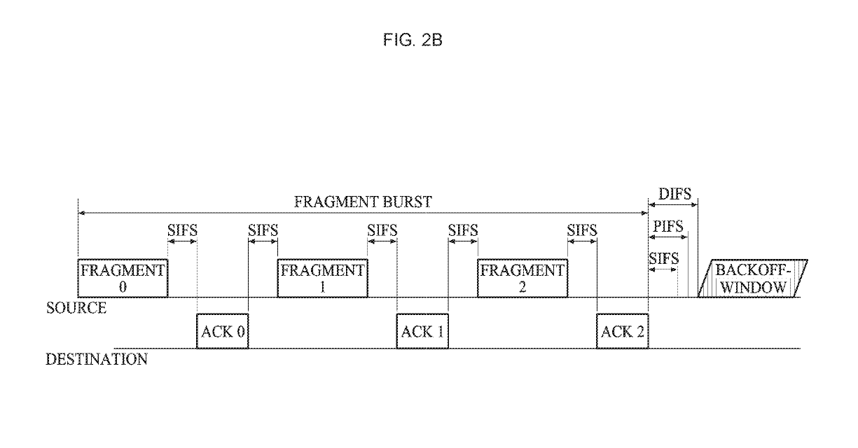

Hereinafter, the split transmission (fragmentation) scheme is described in detail with reference to FIGS. 2A and 2B.

FIGS. 2A and 2B illustrate embodiments of a split transmission scheme of IEEE 802.11 MAC.

Referring to FIG. 2A, the split transmission scheme is a scheme of reducing the size of frame to be transmitted, and may include a service data unit (MSDU, 210) and a plurality of fragments 220.

More particularly, the fragments 220 formed by splitting the service data unit into small MAC fragments are provided, and the fragments 220 includes MAC HDR 221, Frame Body 222, and CRC 223.

In accordance with an embodiment, the MAC HDR 221 may include at least one of a frame control field, a duration/ID field, and an address field, the frame control field may include control information necessary for frame transmission/reception, and the duration/ID field maybe set to a time for transmitting the frame.

FIG. 2B illustrates fragment burst transmission wherein the fragments 220 are split and continuously transmitted.

More particularly, when each split fragment (fragments 0, 1 and 2) is transmitted, a transmitter (source) transmits one fragment 0 and then receives an acknowledgment signal (ACK 0) therefor after a Short Inter-Frame Space (SIFS), followed by waiting for SIFS for the next transmission. In addition, the transmitter transmits Fragment 1 after a certain SIFS and receives an acknowledgment signal (ACK 1) therefor after SIFS, followed by waiting for the next transmission.

After the fragment burst transmission, the transmitter may sequentially transmit a first fragment (fragment 0) including a physical header after considering back-off after a constant frame space (SIFS, Point Coordination Function Inter-Frame Space (PIFS, PCF IFS), and Distributed Coordination Function Inter-Frame Space (DIFS, DCF IFS)).

As described above, when FIGS. 2A and 2B are examined, the split transmission scheme, as a manner of splitting a service data unit received from an upper layer (LLC layer) into a plurality of service data units having the same length and transmitting the split data units, may sequentially transmit a plurality of split service data units in order and thus may increase a transmission success probability and reliability by reducing the size of a frame to be transmitted.

Referring again FIG. 1, the MAC layer management unit 130 of the device for transmitting a data unit 100 according to an embodiment of the present disclosure generates plural MPDUs based on the plurality of split service data units and the delimiter for each of the plurality of split service data units, generates an aggregate protocol data unit by applying an aggregate transmission scheme to the generated plural protocol data units, and delivers the generated aggregate protocol data unit to the physical layer 160.

The MAC layer management unit 130 may transform the plural protocol data units into an aggregate protocol data unit using an aggregate transmission scheme to constitute one frame, and may deliver the frame to the physical layer 160 by adding a physical header to the frame.

For example, the physical header may include a field that includes information on the aggregate protocol data unit to be transmitted.

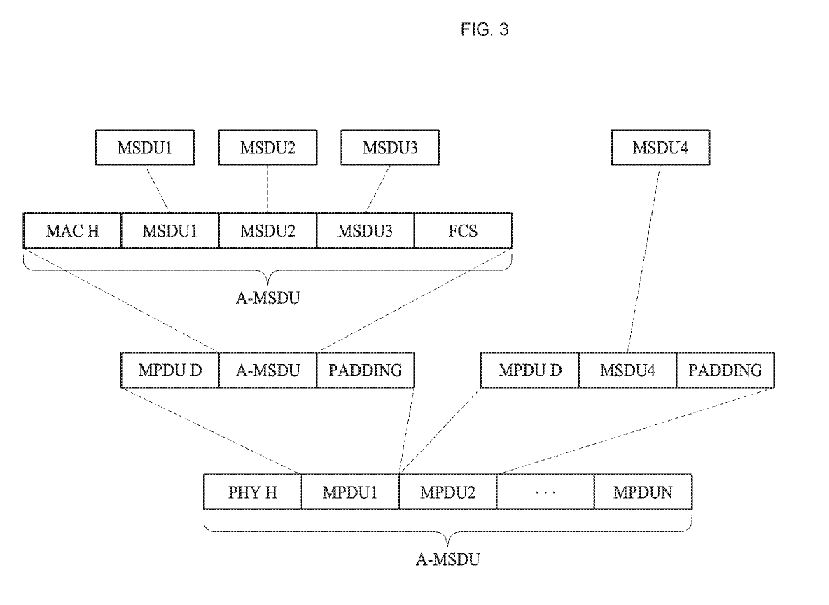

Hereinafter, the aggregate transmission (aggregation) scheme is described in detail with reference to FIG. 3.

FIG. 3 illustrates an embodiment of an aggregate transmission scheme of IEEE 802.11 MAC.

Referring to FIG. 3, the aggregate transmission scheme is a scheme of generating a longer frame by aggregating plural frames into one frame and delivering the generated longer frame, and may be classified into two manners, i.e., an aggregate service data unit (Aggregated-MSDU, A-MSDU) manner and an aggregate protocol data unit (Aggregated-MPDU, A-MPDU) manner.

More particularly, the aggregate protocol data unit manner is a manner of aggregating plural protocol data units, which are transmitted to the same address, into one Physical Service Data Unit (PSDU). The aggregate protocol data unit is composed of plural protocol data units, and may be composed of a protocol data unit delimiter (MPDU Delimiter) to respectively distinguish the plural protocol data units, a service data unit (MSDU) and a pad bit.

In addition, each of the plural protocol data units may include a service data unit (MSDU) or an aggregate service data unit (A-MSDU), and the aggregate service data unit may be composed of plural service data units (MSDUs), a MAC header, and FCS.

As described above, the aggregate transmission scheme reduces overheads, such as a header and FCS, constituting each frame by generating plural frames to be transmitted into one long frame and then transmitting the generated long frame, thus increasing a throughput.

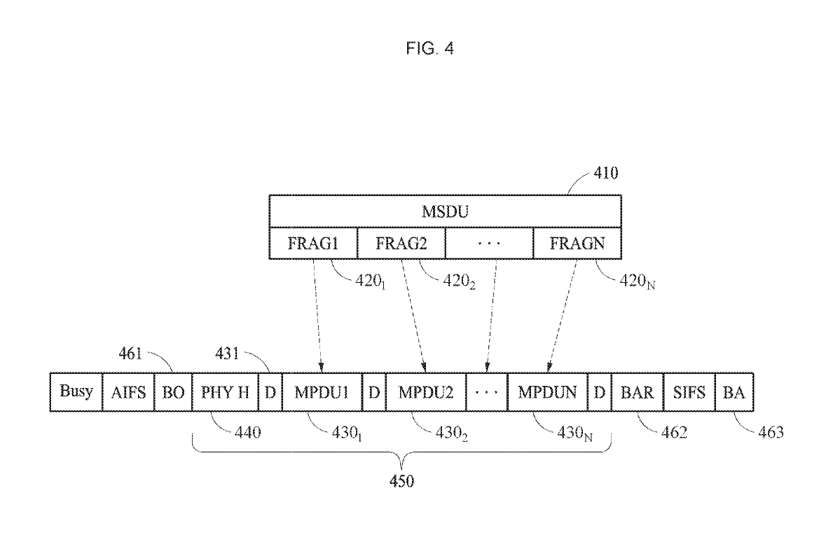

FIG. 4 illustrates an embodiment of a structure produced by means of a device for transmitting a data unit according to an embodiment of the present disclosure.

Referring to FIG. 4, the device for transmitting a data unit according to an embodiment of the present disclosure includes plural fragments (service data units, 420) formed by splitting a service data unit (MSDU) 410 to an optimal split size, generates plural protocol data units 430 based on a delimiter 431 for each of the plural fragments 420 split to a constant length, and represents an aggregate protocol data unit 450 including the generated plural Protocol data units 430 and a physical header 440.

The generated aggregate protocol data unit 450 is delivered to a physical layer. Referring to FIG. 4, BO 461 indicates a back-off as a time delay between an end point of a transmission frame and a transmission start time of the next frame, BAR 462 indicates a Block ACK Request, as a blocked response request to verify from a receiver whether normal transmission has been completed, and BA 463 indicates Block ACK.

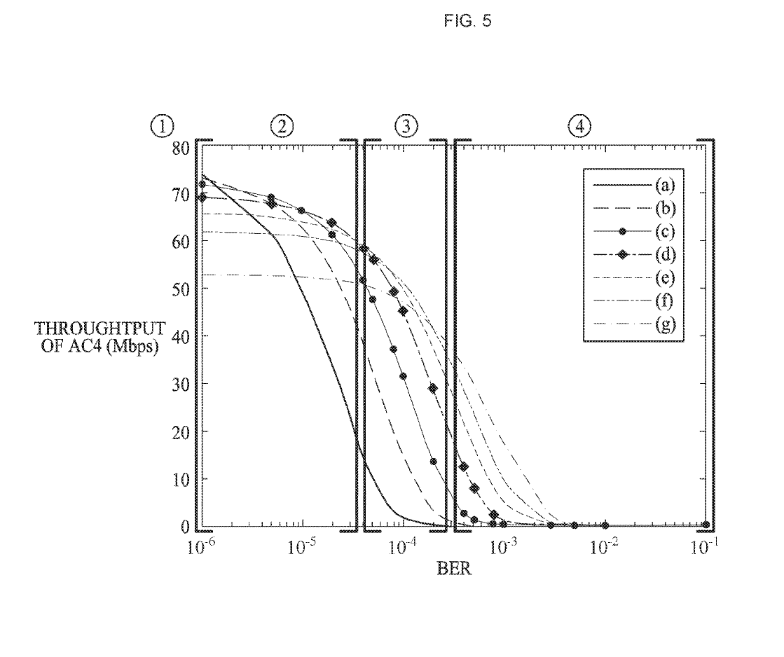

FIG. 5 illustrates simulation result data of a MAC algorithm environment realized by means of a device for transmitting a data unit according to an embodiment of the present disclosure.

More particularly, FIG. 5 illustrates the throughput for the size of each of service data units, to which a split transmission scheme has been applied, according to a Bit Error Rate (BER) in a channel environment of MCS8 78 Mbps.

In addition, in FIG. 5, (a) represents a graph of the throughput according to BER for a long 5000-byte frame to which a split transmission scheme has not been applied, (b) represents a graph of the throughput according to BER for a 2000-byte frame to which a split transmission scheme has been applied, and (c) represents a graph of the throughput according to BER for a 1000-byte frame to which a split transmission scheme has been applied.

In addition, (d) represents a graph of the throughput according to BER for a 500-byte frame to which a split transmission scheme has been applied, (e) represents a graph of the throughput according to BER for a 300-byte frame to which a split transmission scheme has been applied, (f) represents a graph of the throughput according to BER for a 200-byte frame to which a split transmission scheme has been applied, and (g) represents a graph of the throughput according to BER for a 100-byte frame to which a split transmission scheme has been applied.

FIG. 5 illustrates throughput results of frames having different lengths (bytes) according to sections \textcircled{1}, \textcircled{2}, \textcircled{3} and \textcircled{4} that are set according to error occurrence environments using the device for transmitting a data unit according to an embodiment of the present disclosure.

Referring to FIG. 5, it can be confirmed that, in section \textcircled{1}, an environment with few errors, in which BER is about 10⁻⁶ or less, (a), wherein a split transmission scheme has not applied to a long 5000-byte frame that has been received from an upper layer (LLC layer), represents a throughput of 74 Mbps, thus exhibiting best performance.

In addition, it can be confirmed that, in section \textcircled{2} in which BER is about 10⁻⁶ to about 4·10⁻⁵, (c) having a constant 1000-byte length exhibits a throughput of about 68 to about 70 Mbps and the best performance. (c) represents a service data unit having a constant 1000-byte length formed by splitting a 5000-byte service data unit, which have been received from an upper layer, into 1/5 using a split transmission scheme.

In addition, it can be confirmed that, in section \textcircled{3} in which BER is about 4·10⁻⁵ to 4·10⁻⁴, (f) having a constant 200-byte length exhibits the highest throughput and the best performance. (f) represents a service data unit having a constant 200-byte length formed by splitting the 5000-byte service data unit, which has received from an upper layer, into 1/5² using a split transmission scheme.

In addition, it can be confirmed that, in section \textcircled{4} in which BER is about 4·10⁻⁴ or more and which are vulnerable to error, (g) having a constant 100-byte length represents the highest throughput and the best performance. (g) represents a service data unit having a constant 100-byte length, as a smallest length, formed by applying a split transmission scheme to the 5000-byte service data unit that has been received from an upper layer.

Therefore, referring to FIG. 5, it can be confirmed that, in sections \textcircled{2}, \textcircled{3} and \textcircled{4} in which error occur, high throughput performance is superior with decreasing service data unit size through application of the split transmission scheme, and, in section \textcircled{4}, the throughput performance of the service data units e, f, and g having a length of 300 byte or less is gradually decreased.

In accordance with an embodiment, in the case of an environment in which it is difficult to verify channel state information, throughput may be increased while guaranteeing reliability by splitting a service data unit into a 500 to 1000-byte size using a split transmission scheme and transmitting the split data units.

In addition, the MCS8 780 Mbps channel environment exhibits the same performance result as the MCS8 78 Mbps channel environment.

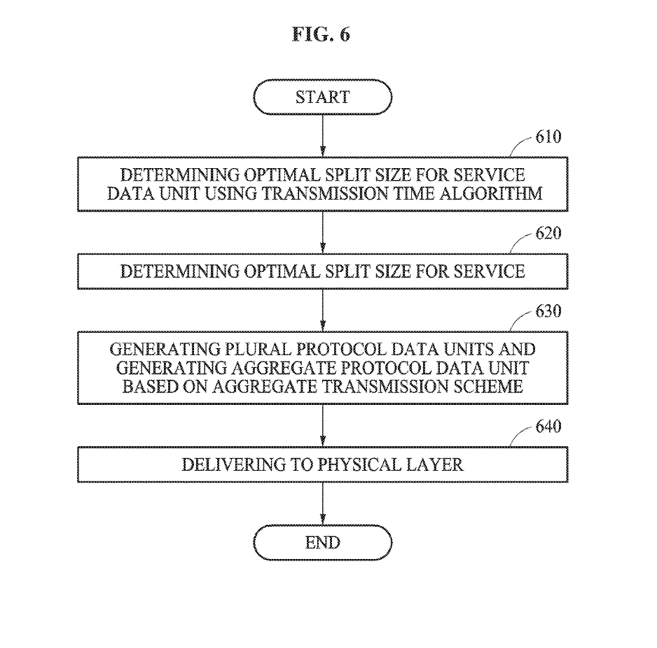

FIG. 6 is a flowchart illustrating a method of transmitting a data unit according to an embodiment of the present disclosure.

As illustrated in FIG. 6, in Step 610, an optimal split size for a service data unit received from an upper layer is determined applying a transmission time algorithm.

Step 610 may be a step of determining an optimal split size by calculating a maximum length of a frame, which can be transmitted during a Transmission Opportunity (TXOP) limit time of a terminal, and a transmission time to transmit the frame to a maximum length using a transmission time algorithm. In addition, Step 610 may be a step of determining an optimal split size by calculating the throughput for performance evaluation using a transmission time algorithm.

Step 610 may be a step of determining an optimal split size for a service data unit received from an upper layer based on a channel environment.

In Step 620, the service data unit is split into the determined size. Step 620 may be a step of determining split of the service data unit received from an upper layer based on an environment with or without error.

For example, in Step 620, the service data unit received from an upper layer is not split in an environment in which error does not occur, but is split based on the determined size using the split transmission scheme in an environment in which error occurs.

In Step 630, plural MAC Protocol Data Units (MPDUs) are generated based on the split plural service data units and the delimiter for each of the split plural service data units, and an aggregate protocol data unit is generated by applying an aggregate transmission scheme to the generated plural MPDUs.

For example, Step 630 may be a step of constituting one frame by generating the plural MPDUs into an aggregate protocol data unit using an aggregate transmission scheme.

In Step 640, the generated aggregate protocol data unit is delivered to a physical layer. Step 640 may be a step of adding one physical header to one frame composed of the aggregate protocol data unit and delivering the same to a physical layer.

As apparent from the above description, in accordance with an embodiment of the present disclosure, reliability, which is important for video streaming, may be guaranteed and, at the same time, the throughput may be increased in unmanned aircraft communication by using a split transmission scheme and an aggregate transmission scheme, the characteristics of which are incompatible with each other and which are optimized for uplink image data transmission, together.

In addition, in accordance with an embodiment of the present disclosure, high throughput performance may be achieved even in environments with error due to a split optimal service data unit size and an aggregated optimal protocol data unit size by using a split transmission scheme and an aggregate transmission scheme, the characteristics of which are incompatible with each other, together,.

Further, in accordance with an embodiment of the present disclosure, an optimal service data unit size for each channel environment may be detected by using a split transmission scheme and an aggregate transmission scheme together.

Although exemplary embodiments of the present invention have been disclosed for illustrative purposes, those skilled in the art will appreciate that various modifications, additions and substitutions are possible, without departing from the scope and spirit of the invention as disclosed in the accompanying claims. For example, proper result may be achieved even if the techniques described above are implemented in an order different from that for the disclosed method, and/or disclosed constituents such as a system, structure, device and circuit are coupled to or combined with each other in a form different from that for the disclosed method or replaced by other constituents or equivalents.

It should be understood, however, that there is no intent to limit the invention to the embodiments disclosed, rather, the invention is to cover all modifications, equivalents, and alternatives falling within the spirit and scope of the invention as defined by the claims.

### DESCRIPTION OF SYMBOLS

100: DEVICE FOR TRANSMITTING DATA UNIT

110: SIZE DETERMINATION UNIT

120: UNIT DIVISION UNIT

130: MAC LAYER MANAGEMENT UNIT

140: UPPER LAYER

150: MAC LAYER

160: PHYSICAL LAYER

What is claimed is:

1. A device for a transmitting data unit, comprising:
a size determination unit for determining an optimal split size for a MAC Service Data Unit (MSDU) received from an upper layer by applying a transmission time algorithm;
a unit division unit for splitting the MSDU into the determined size; and
a MAC layer management unit for generating plural MAC Protocol Data Units (MPDUs) based on the split plural MSDUs and a delimiter for each of the split plural MSDUs, generating an aggregate protocol data unit by applying an aggregate transmission scheme to the generated MPDUs, and delivering the generated aggregate protocol data unit to a physical layer.

2. The device according to claim 1, wherein the size determination unit determines an optimal split size by calculating a maximum length of a frame that can be transmitted during a Transmission Opportunity (TXOP) limit time of a terminal using a transmission time algorithm and calculating a frame transmission time from the calculated frame maximum length.

3. The device according to claim 2, wherein the size determination unit determines the optimal split size by calculating throughput for performance evaluation using the transmission time algorithm.

4. The device according to claim 3, wherein the size determination unit determines the optimal split size for the MSDU received from the upper layer based on a channel environment.

5. The device according to claim 1, wherein the unit division unit determines split of the MSDU received from the upper layer based on an environment with or without error.

6. The device according to claim 5, wherein the unit division unit does not split the MSDU received from the upper layer in an environment in which error does not occur, but splits the MSDU, received from the upper layer, based on the size determined by the size determination unit using a split transmission scheme in an environment in which error occurs.

7. The device according to claim 1, wherein the aggregate transmission scheme constitutes one frame by generating the plural MPDUs into the aggregate protocol data unit.

8. The device according to claim 7, wherein the MAC layer management unit adds one physical header to the one frame and delivers the physical header-added frame to the physical layer.

9. A method of transmitting a data unit, the method comprising:
determining an optimal split size for an MSDU received from an upper layer by applying a transmission time algorithm;
splitting the MSDU into the determined size;
generating plural MPDUs based on the split plural MSDUs and a delimiter for each of the split plural MSDUs and generating an aggregate protocol data unit by applying an aggregate transmission scheme to the generated plural MPDUs; and
delivering the generated aggregate protocol data unit to a physical layer.

10. The method according to claim 9, wherein, in the determining, the optimal split size is determined by calculating a maximum length of a frame, which can be transmitted during a Transmission Opportunity (TXOP) limit time of a terminal using the transmission time algorithm, and a transmission time to transmit the frame to the maximum length.

11. The method according to claim 10, wherein, in the determining, the optimal split size is determined by calculating a throughput for performance evaluation using the transmission time algorithm.

12. The method according to claim 11, wherein, in the determining, an optimal split size for the MSDU received from the upper layer is determined based on a channel environment.

13. The method according to claim 9, wherein, in the splitting, split of the MSDU received from the upper layer is determined based on an environment with or without error.

14. The method according to claim 13, wherein, in the splitting, the MSDU received from the upper layer is not split in an environment in which error does not occur, but the MSDU received from the upper layer is split based on the determined size using a split transmission scheme in an environment in which error occurs.

15. The method according to claim 9, wherein, in the delivering, one physical header is added to one frame composed of the aggregate protocol data unit, and the physical header-added frame is delivered to the physical layer.
